(19) United States
(12) Patent Application Publication
(10) Pub. No.: US 2026/0322924 A1
(43) Pub. Date: Oct. 15, 2026

(54) CAPTURE SYSTEM, COMPUTER-READABLE, NON-TRANSITORY RECORDING MEDIUM HAVING CAPTURE PROGRAM RECORDED THEREON, IMAGE READING APPARATUS, COMPUTER-READABLE, NON-TRANSITORY RECORDING MEDIUM HAVING WORKFLOW EXECUTION PROGRAM RECORDED THEREON, AND SYSTEM

(71) Applicant: KYOCERA Document Solutions Inc., Osaka (JP)

(72) Inventors: Hiroshi MANABE, Osaka (JP); Ryusuke NAKATANI, Osaka (JP)

(73) Assignee: KYOCERA Document Solutions Inc., Osaka (JP)

(21) Appl. No.: 19/462,433

(22) Filed: Jan. 28, 2026

(30) Foreign Application Priority Data
Jan. 29, 2025 (JP) 2025-013036

(51) Int. Cl. H04N 1/00; G06F 16/16

(52) U.S. Cl. CPC H04N 1/00241; G06F 16/164; H04N 1/00244; H04N 1/00411; H04N 2201/0068; H04N 2201/0094

(57) ABSTRACT

A capture system includes a capturer. The capturer executes a workflow including executing a specific process with respect to an inputted document, and outputting a file representing an execution result, to a specific destination. The capturer stores therein a rule for generating a file name, representing a name of the file, with respect to each of the workflows. Upon receipt of only identification information, out of the identification information of the workflow and the document, the capturer generates a sample of the file name according to the rule, and transmits the sample to a transmission source of the identification information. Upon receipt of the document from the transmission source, the capturer assigns the file name according to the rule, to the file.

### INCORPORATION BY REFERENCE

This application claims priority to Japanese Patent Application No. 2025-013036 filed on Jan. 29, 2025, the entire contents of which are incorporated by reference herein.

### BACKGROUND

The present disclosure relates to a capture system that executes a workflow, including executing a specific processing with respect to an inputted document, and outputting a file representing an execution result to a specific destination, a computer-readable, non-transitory recording medium having the capture program recorded thereon, an image reading apparatus, a computer-readable, non-transitory recording medium having a workflow execution program recorded thereon, and a system.

A system is known that includes the capture system, configured to executes the workflow including executing a specific processing with respect to an inputted document, and outputting the file representing the execution result to a specific destination, and an image reading apparatus that reads an image from the document, and transmits the read image to the capture system, in the form of a document.

### SUMMARY

The disclosure proposes further improvement of the foregoing technique.

In an aspect, the disclosure provides a capture system including a first control device. The first control device includes a processor, and acts as a capturer, when the processor executes a capture program. The capturer executes a workflow including executing a specific process with respect to an inputted document, and outputting a file representing an execution result, to a specific destination. The capturer stores therein a rule for generating a file name, representing a name of the file, with respect to each of the workflows. Upon receipt of only identification information, out of the identification information of the workflow and the document, the capturer generates a sample of the file name according to the rule, and transmits the sample to a transmission source of the identification information. Upon receipt of the document from the transmission source, the capturer assigns the file name according to the rule, to the file.

In another aspect, the disclosure provides a computer-readable, non-transitory recording medium having a capture program recorded thereon. The capture program causes the computer to act as a capturer. The capturer executes a workflow including executing a specific process with respect to an inputted document, and outputting a file representing an execution result, to a specific destination. The capturer stores therein a rule for generating a file name, representing a name of the file, with respect to each of the workflows. Upon receipt of only identification information, out of the identification information of the workflow and the document, the capturer generates a sample of the file name according to the rule, and transmits the sample to a transmission source of the identification information. Upon receipt of the document from the transmission source, the capturer assigns the file name according to the rule, to the file.

In still another aspect, the disclosure provides an image reading apparatus including a reading device, a display device, and a second control device. The reading device reads an image from a source document. The second control device includes a processor, and acts as a workflow executer, when the processor executes a workflow execution program. The workflow executer causes a capture system that executes a workflow including executing a specific process with respect to a document, and outputting a file representing an execution result to a specific destination, to execute the workflow. After transmitting only identification information, out of the identification information of the workflow and the document, the workflow executer receives a sample of a file name, representing a name of the file, from the capture system, and displays the sample on the display device. After displaying the sample, the workflow executer reads the image from the source document using the reading device, and transmits the image to the capture system, as the document.

In still another aspect, the disclosure provides a system including a capture system, and the foregoing image reading apparatus. The capture system includes a first control device. The first control device includes a processor, and acts as a capturer, when the processor executes a capture program. The capturer executes a workflow including executing a specific process with respect to an inputted document, and outputting a file representing an execution result, to a specific destination. Upon receipt of the document from the image reading apparatus, the capturer assigns the file name according to a predetermined rule for generating the file name representing the name of the file, to the file.

### BRIEF DESCRIPTION OF THE DRAWINGS

FIG. 1 is a block diagram showing a configuration of a capture system according to an embodiment of the disclosure;

FIG. 2 is a block diagram showing a configuration of the capture system shown in FIG. 1, constituted of a single PC;

FIG. 3 presents an example of the user management information shown in FIG. 2;

FIG. 4 presents an example of the workflow management information shown in FIG. 2;

FIG. 5 is a block diagram showing a configuration of the user terminal shown in FIG. 1, constituted of a PC;

FIG. 6 is a block diagram showing a configuration of the image reading apparatus shown in FIG. 1, configured as an MFP;

FIG. 7 is a sequence chart showing an operation of the system shown in FIG. 1, performed when the user logs in to the capture system from the user terminal;

FIG. 8 is a schematic drawing showing an example of the log-in page, displayed in the operation shown in FIG. 7;

FIG. 9 is a sequence chart showing an operation of the system shown in FIG. 1, performed when setting a file name;

FIG. 10 is a schematic drawing showing an example of the file name setting page, displayed in the operation shown in FIG. 9;

FIG. 11 is a sequence chart showing an operation of the system shown in FIG. 1, performed when the user logs in to the capture system from the image reading apparatus;

FIG. 12 is a schematic drawing showing an example of the log-in screen, displayed in the operation shown in FIG. 11;

FIG. 13 is a sequence chart showing an operation of the system shown in FIG. 1, performed when the capture system executes a workflow;

FIG. 14 is a flowchart showing the file name generation process included in FIG. 13;

FIG. 15 is a schematic drawing showing an example of the scan setting screen, displayed in the operation shown in FIG. 13;

FIG. 16 is a schematic drawing showing an example of the scan setting screen shown in FIG. 15, including a note;

FIG. 17 is a sequence chart showing an operation of the system shown in FIG. 1, performed when a file name button is pressed;

FIG. 18 is a schematic drawing showing an example of the file name editing screen, displayed in the operation shown in FIG. 17;

FIG. 19 is a flowchart showing the file name changing process included in FIG. 17;

FIG. 20 is a sequence chart showing an operation of the system shown in FIG. 1, performed when a scan button is pressed; and

FIG. 21 is a flowchart showing the file name determination process included in FIG. 20.

### DETAILED DESCRIPTION

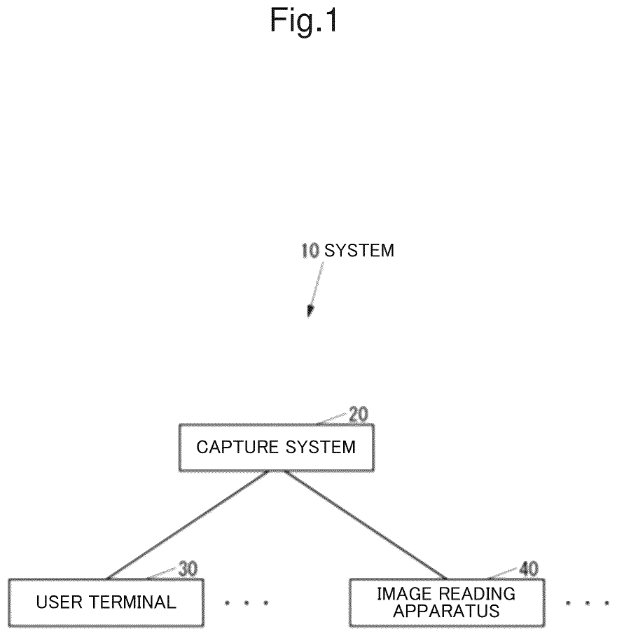

First, a configuration of a system according to an embodiment of the disclosure will be described. FIG. 1 is a block diagram showing the system 10 according to the embodiment.

As shown in FIG. 1, the system 10 includes a capture system 20, configured as a web application that executes a specific processing with respect to an inputted document, and outputs the processing result to a specific destination. The capture system 20 may be constituted of a single computer such as a personal computer (PC), acting as a capturing device, or a plurality of computers. The capture system 20 may be provided on a cloud.

The system 10 includes a user terminal 30, to be utilized by the user of the capture system 20. The system 10 may additionally include one or more user terminals configured similarly to the user terminal 30. The user terminal 30 may be, for example, constituted of a PC, a smartphone, or a tablet.

The system 10 includes an image reading apparatus 40, for inputting an image read from a document by a scanner to be subsequently described (hereinafter, “scanned image”), to the capture system 20 as a document. The system 10 may additionally include one or more image reading apparatuses configured similarly to the image reading apparatus 40. The image reading apparatus 40 may be, for example, constituted of a single-function scanner, or a multifunction peripheral (MFP).

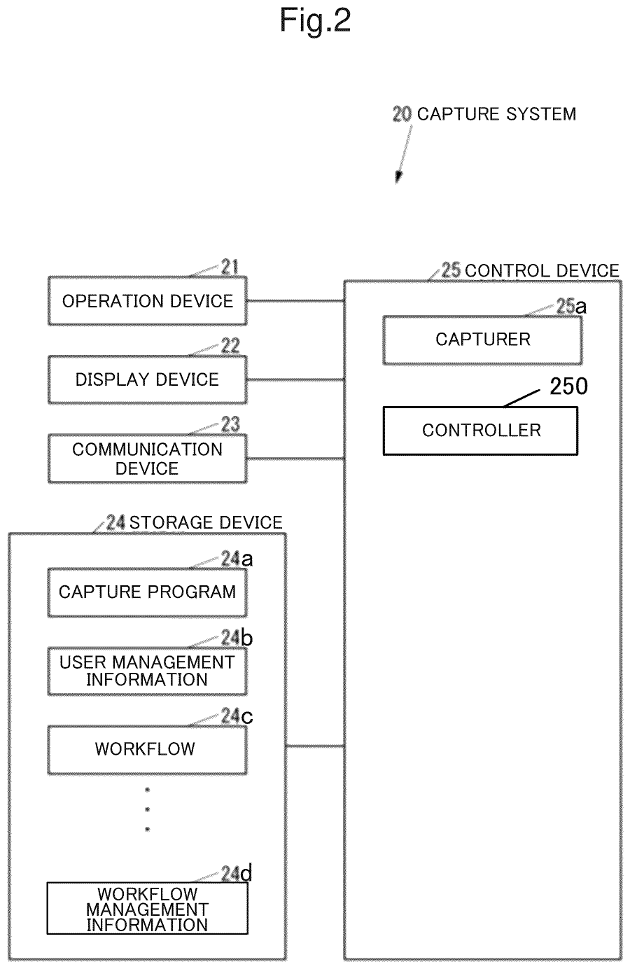

FIG. 2 is a block diagram showing a configuration of the capture system 20, constituted of a single PC.

As shown in FIG. 2, the capture system 20 includes an operation device 21 including, for example, a keyboard and a mouse for inputting various operations, a display device 22, for example including a liquid crystal display (LCD) for displaying various types of information, a communication device 23 that performs communication with an external device, via a network such as a local area network (LAN) or the internet, or directly through wired or wireless communication, a storage device 24 including a non-volatile memory unit such as a semiconductor memory or a hard disk drive (HDD), for storing various types of information, and a control device 25 that controls the overall operation of the capture system 20.

The storage device 24 contains a capture program 24a, for executing a specific process with respect to an inputted document, and outputting the execution result to a specific destination. The capture program 24a may be, for example, installed in the capture system 20 during the manufacturing process thereof, stored in an external storage medium such as a universal serial bus (USB) memory and additionally installed in the capture system 20 from such storage medium, or additionally installed in the capture system 20 from a network.

The storage device 24 contains user management information 24b for managing the users of the capture system 20.

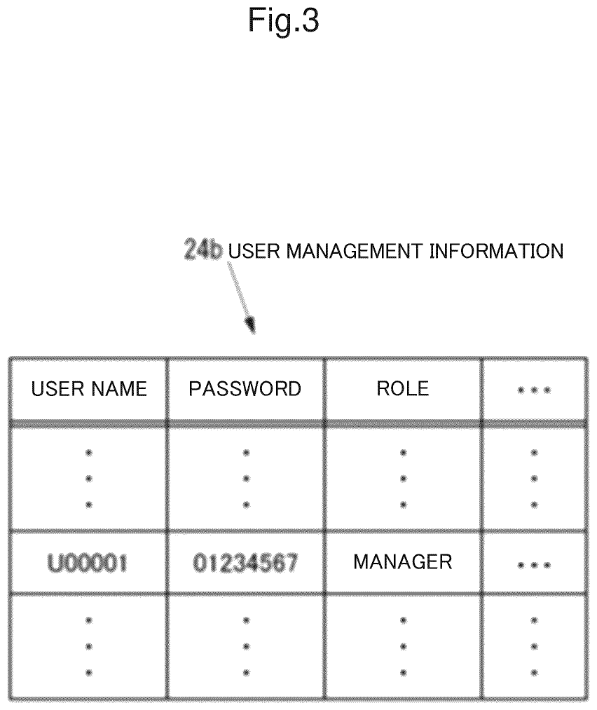

FIG. 3 presents an example of the user management information 24b. As shown in FIG. 3, the user management information 24b includes “user name” serving as the identification information of the user, “password” of the user, and “role” of the user. Examples of the “role” include a manager and a general user. The user management information 24b shown in FIG. 3 only shows a part of specific values.

As shown in FIG. 2, the storage device 24 contains a workflow 24c, for executing a specific process with respect to a document inputted to the capture system 20, and outputting the execution result to a specific destination. The storage device 24 may additionally include one or more workflows configured similarly to the workflow 24c. The workflow may be generated by the manager. Examples of the operation specified in the workflow include image processing with respect to a, converting the file format of the document, assigning a name of the file (hereinafter, “file name”) to the document, and sorting to identify the destination to which the execution result is to be outputted. Examples of the image processing specified in the workflow include optical character recognition (OCR) to extract characters contained in the image of the document, a background noise elimination process for eliminating background noise from the image of the document, deskewing the image of the document, for example in a range of approximately −5° to 5°, and automatic image rotation, for automatically rotating the image of the document by increments of 90°.

The storage device 24 stores therein workflow management information 24d for managing the workflow.

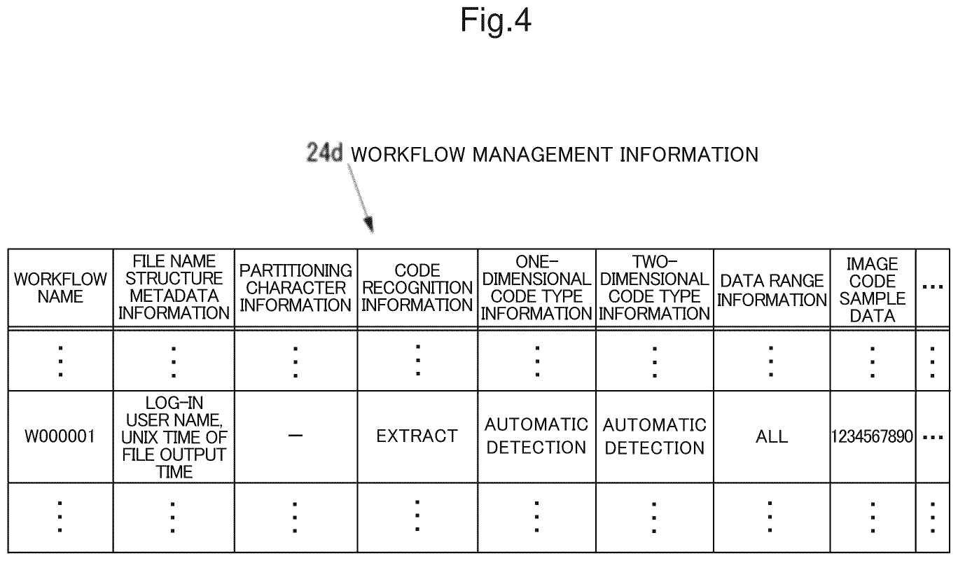

FIG. 4 illustrates an example of the workflow management information 24d.

As shown in FIG. 4, the workflow management information 24d includes, with respect to each of the workflows, the name of the workflow (hereinafter, “workflow name”); file name structure metadata information indicating items of metadata used for the file name, out of the items of the metadata of the document generated by executing the workflow, along with the order of being used for the file name; partitioning character information indicating a partitioning character for the case of using a plurality of pieces of metadata for the file name; code recognition information indicating whether to extract data from the image code, for setting the file name; one-dimensional code type information indicating the type of one-dimensional code, constituting the image code, from which the data is to be extracted; two-dimensional code type information indicating the type of two-dimensional code, constituting the image code, from which the data is to be extracted; data range information indicating a range of data to be written in the item “image code” of the metadata, among the data extracted from the image code; and image code sample data indicating a sample of the data to be extracted from the image code. The file name structure metadata information, the partitioning character information, the code recognition information, the one-dimensional code type information, the two-dimensional code type information, the data range information, and the image code sample data constitute the rule for generating the file name. The workflow management information 24d shown in FIG. 4 only shows a part of specific values.

Examples of the items of the metadata that may be indicated by the file name structure metadata information include item related to time (hereinafter, “time-related item”), “UNIX time” indicating the UNIX time in the order of milliseconds, “log-in user name” indicating the user name of the user who has logged in to the capture system 20, “workflow name” indicating the name of the workflow, and “image code” indicating the data extracted from the image code included in the document.

For example, the time-related item includes “year” indicating the year in MM/DD/YYYY, “month” indicating the month in MM/DD/YYYY, “date” indicating the day in MM/DD/YYYY, “hour (24-hour format)” indicating the hour in hr/min/sec in the 24-hour format, “hour (12-hour format)” indicating the hour in hr/min/sec in the 12-hour format, “minute” indicating the minute in hr/min/sec, and “second” indicating the second in hr/min/sec. The “year” is expressed by Common Era in four digits, such as “2025”. The “month”, “date”, “hour (24-hour format)”, “hour (12-hour format)”, “minute”, and “second” are expressed in two digits. For example, June is expressed as “06”. For each of “year”, “month”, “date”, “hour (24-hour format)”, “hour (12-hour format)”, “minute”, and “second”, which of the time that the start of the workflow has been notified to the capture system 20 (hereinafter, “workflow start notice time”), and the time that the capture system 20 has outputted the document file (hereinafter, “file output time”), each of those items corresponds to, is designated.

For the “UNIX time”, which of the workflow start notice time and the file output time it corresponds to, is designated.

The order of display of the items in the file name structure metadata information corresponds to the order in which the item appears in the file name.

Examples of the partitioning character indicated by the partitioning character information include “-” (hyphen), “_” (underscore), “.” (period), and “ ” (space).

The type of the one-dimensional code indicated by the one-dimensional code type information may be a specific type, or “automatic detection” indicating that the capture system 20 automatically detects the type. In the case of “automatic detection”, a specific type of the one-dimensional barcode that the capture system 20 attempts to detect, when the automatic detection has failed, may be designated.

The type of the two-dimensional code indicated by the two-dimensional code type information may be a specific type, or “automatic detection” indicating that the capture system 20 automatically detects the type. In the case of “automatic detection”, a specific type of the two-dimensional barcode that the capture system 20 attempts to detect, when the automatic detection has failed, may be designated.

The range indicated by the data range information may be, for example, all the data extracted from the image code included in the document, or a specific range in the data extracted from the image code included in the document, such as from the X-th to Y-th characters from the head.

The control device 25 shown in FIG. 2 includes, for example, a processor such as a central processing unit (CPU), a read-only memory (ROM) containing programs and various types of data, and a random-access memory (RAM) serving as the operating region for the processor. The processor acts as a controller 250, by executing the program stored in the storage device 24 or the ROM of the control device 25. The processor exemplifies the computer in the disclosure, and the control device 25 exemplifies the first control device in the disclosure.

The processor of the control device 25 acts, by executing the capture program 24a, as a capturer 25a that executes the workflow, including executing a specific processing with respect to the inputted document, and outputting the execution result to a specific destination.

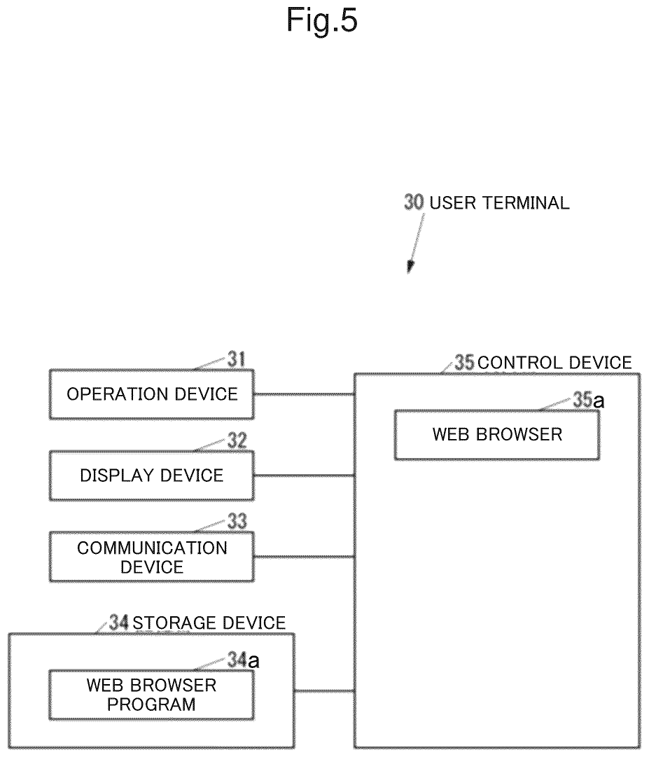

FIG. 5 is a block diagram showing a configuration of the user terminal 30, constituted of a PC.

As shown in FIG. 5, the user terminal 30 includes an operation device 31 including, for example, a keyboard and a mouse for inputting various operations, a display device 32, for example including a liquid crystal display (LCD) for displaying various types of information, a communication device 33 that performs communication with an external device, via a network such as a local area network (LAN) or the internet, or directly through wired or wireless communication, a storage device 34 including a non-volatile memory unit such as a semiconductor memory or an HDD, for storing various types of information, and a control device 35 that controls the overall operation of the user terminal 30.

The storage device 34 contains a program for the web browser (hereinafter, “web browser program”) 34a. The web browser program 34a may be, for example, installed in the user terminal 30 during the manufacturing process thereof, additionally installed in the user terminal 30 from an external storage medium such as a USB memory, or additionally installed in the user terminal 30 from the network.

The control device 35 includes, for example, a CPU, a ROM containing programs and various types of data, and a RAM serving as the operation region for the CPU of the control device 35. The CPU of the control device 35 executes the program stored in the storage device 34 or the ROM of the control device 35.

The control device 35 realizes a web browser 35a, by executing the web browser program 34a.

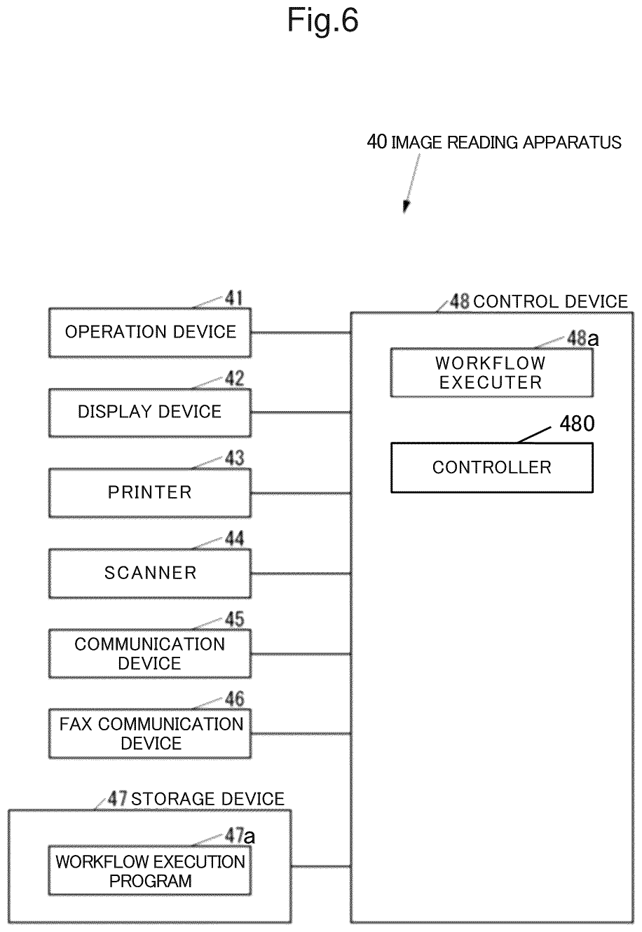

FIG. 6 is a block diagram showing a configuration of the image reading apparatus 40, configured as an MFP.

As shown in FIG. 6, the image reading apparatus 40 is a computer, including an operation device 41 including, for example, buttons for inputting various operations, a display device 42, for example including an LCD for displaying various types of information, a printer 43 that prints an image on a recording medium such as a paper sheet, a scanner 44 that reads an image from a document, a communication device 45 that performs communication with an external device, via a network such as a LAN or the internet, or directly through wired or wireless communication, a facsimile communication device 46 that performs facsimile communication with a non-illustrated external facsimile machine, via a communication line such as a public telephone network, a storage device 47 including a non-volatile memory unit such as a semiconductor memory or an HDD, for storing various types of information, and a control device 48 that controls the overall operation of the image reading apparatus 40.

The storage device 47 can store therein a workflow execution program 47a, for causing the capture system 20 (see FIG. 2) to execute the workflow. The workflow execution program 47a may be, for example, installed in the image reading apparatus 40 during the manufacturing process thereof, stored in an external storage medium such as a USB memory, and additionally installed in the image reading apparatus 40 from such storage medium, or additionally installed in the image reading apparatus 40 from the network.

The control device 48 includes, for example, a processor such as a central processing unit (CPU), a read-only memory (ROM) containing programs and various types of data, and a random-access memory (RAM) serving as the operating region for the processor. The processor acts as a controller 480, by executing the program stored in the storage device 47 or the ROM of the control device 48. The processor exemplifies the computer provided in the image reading apparatus in the disclosure, and the control device 48 exemplifies the second control device in the disclosure.

The control device 48 acts, by executing the workflow execution program 47a, as a workflow executer 48a that causes the capture system 20 to execute the workflow.

Hereunder, an operation of the system 10 will be described. First, the operation of the system 10, performed when the user logs in to the capture system 20 from the user terminal 30, will be described.

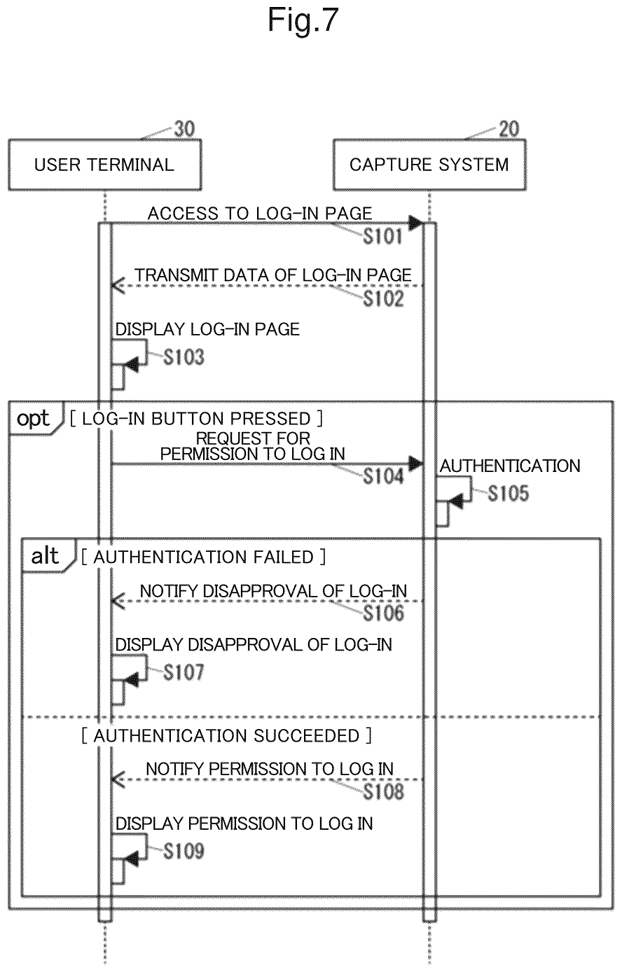

FIG. 7 is a sequence chart showing the operation of the system 10, performed when the user logs in to the capture system 20 from the user terminal 30.

The user of the user terminal 30 instructs the user terminal 30, via the operation device 31 thereof, to make access to the webpage for logging in to the capture system 20 (hereinafter, “log-in page”) provided by the capture system 20. When the instruction to make access to the log-in page provided by the capture system 20 is inputted, the web browser 35a of the user terminal 30 makes access to the log-in page provided by the capture system 20 (S101).

Upon being accessed at S101, the capturer 25a of the capture system 20 transmits the data of the log-in page to the web browser 35a (S102).

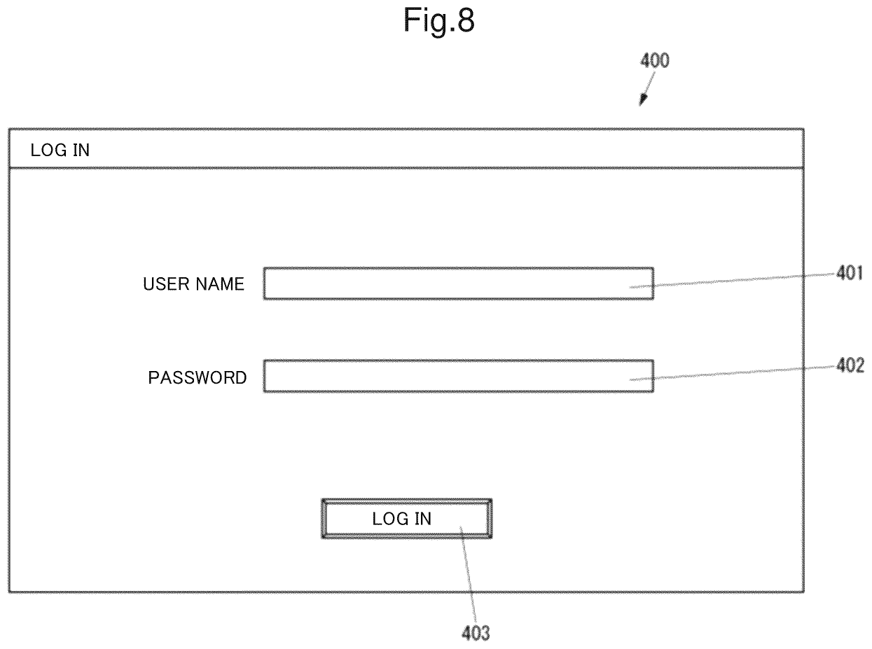

Upon receipt of the data transmitted at s102, the web browser 35a of the user terminal 30 displays the log-in page 400 (see FIG. 8) on the display device 32, according to the data received (S103).

FIG. 8 illustrates an example of the log-in page 400.

The log-in page 400 shown in FIG. 8 includes a textbox 401 user name, textbox 402 which is a widget for inputting the password, and a log-in button 403 for logging in to the capture system 20.

Referring to FIG. 7, when the log-in button 403 is pressed, the web browser 35a of the user terminal 30 requests the capture system 20 for permission for log-in, on the basis of the combination of the user name inputted to the textbox 401 at the time that the log-in button 403 has been pressed, and the password inputted to the textbox 402 at the time that the log-in button 403 has been pressed (S104).

Upon receipt of the request of S104, the capturer 25a of the capture system 20 performs authentication of the user who is the subject of the request of S104 (S105). To be more specific, the capturer 25a decides that the authentication has succeeded, when the combination of the user name and the password, included in the request of S104, is included in the user management information 24b. On the other hand, in the case where the combination of the user name and the password included in the request of S104 is not included in the user management information 24b, the capturer 25a decides that the authentication of the user has failed.

Upon deciding that the authentication performed at S105 has failed, the capturer 25a of the capture system 20 notifies the user terminal 30 that log-in has been rejected (S106).

Upon receipt of the notice of S106, the web browser 35a of the user terminal 30 displays a message to the effect that log-in has been rejected, on the display device 32 (S107).

In contrast, upon deciding that the authentication performed at S105 has succeeded, the capturer 25a of the capture system 20 notifies the user terminal 30 that log-in has been permitted (S108).

Upon receipt of the notice of S108, the web browser 35a of the user terminal 30 displays a message to the effect that log-in has been permitted, on the display device 32 (S109).

Hereunder, an operation of the system 10, performed when executing the setting of a portion of the file name other than the extension (hereinafter, “file name setting”), in the file name to be assigned to the document, will be described.

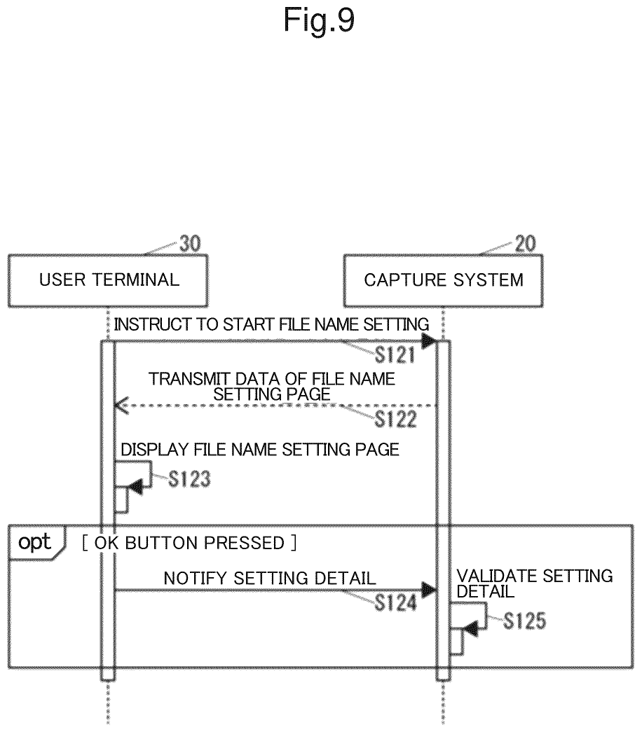

FIG. 9 is a sequence chart showing the operation of the system 10, performed when executing the file name setting.

The manager can instruct, while performing the setting of a specific workflow, in the logged-in state to the capture system 20 from the user terminal 30, the user terminal 30 to start the file name setting with respect to that workflow, via the operation device 31. Upon receipt of the instruction to start the file name setting for the specific workflow, the web browser 35a of the user terminal 30 instructs the capture system 20 to start the file name setting for the workflow, as shown in FIG. 9 (S121).

Upon receipt of the instruction of S121, the capturer 25a of the capture system 20 transmits the data of the webpage for file name setting (hereinafter, “file name setting page”) for the workflow designated in the instruction of S121, to the web browser 35a (S122).

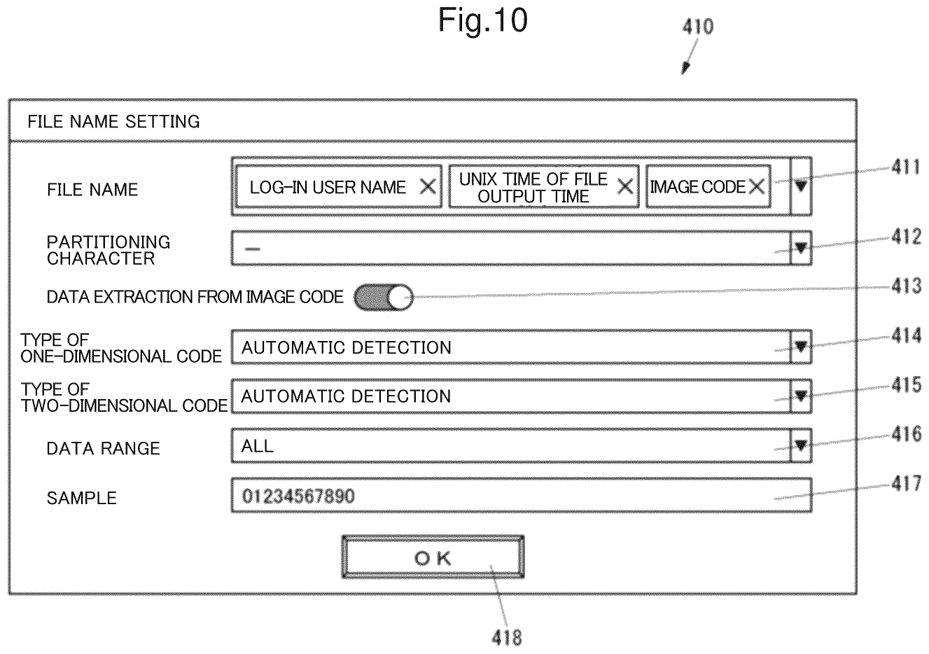

Upon receipt of the data transmitted at S122, the web browser 35a displays a file name setting page 410 (see FIG. 10) on the display device 32, on the basis of the data received (S123).

FIG. 10 illustrates an example of the file name setting page 410.

The file name setting page 410 shown in FIG. 10 includes a multiselect 411, which is a widget for designating the item to be used for the file name, among the items of the metadata of the document, along with the order of use of the item for the file name, a dropdown list 412 which is a widget for designating the partitioning character to be used when a plurality of items are used for the file name, a toggle switch 413 which is a widget for instructing whether to extract data from the image code, to set the file name, a dropdown list 414 which is a widget for designating the type of the data to be extracted, among the types of the one-dimensional code constituting the image code, a dropdown list 415 which is a widget for designating the type of the data to be extracted, among the types of the two-dimensional code constituting the image code, a dropdown list 416 which is a widget for designating the range of the data to be written in the item “image code”, among the data extracted from the image code, a textbox 417 which is a widget for designating the sample of the data to be extracted from the image code, and an OK button 418 which is a widget for executing the file name setting.

For example, examples of the items that can be designated through the multiselect 411 include the time-related item, “UNIX time”, “log-in user name”, “workflow name”, and “image code”.

For example, the time-related item includes “year”, “month”, “date”, “hour (24-hour format)”, “hour (12-hour format)”, “minute”, and “second”. For each of “year”, “month”, “date”, “hour (24-hour format)”, “hour (12-hour format)”, “minute”, and “second”, which of the workflow start notice time and the file output time it corresponds to, can be designated.

In the case of the “UNIX time”, which of the workflow start notice time and the file output time it corresponds to, can be designated.

The order of display of the items in the multiselect 411 indicates the order of appearance of the items in the file name.

The initial values of the item designated through the multiselect 411 are “log-in user name” and “UNIX time”.

Examples of the partitioning character that can be designated through the dropdown list 412 include hyphen, underscore, period, and space. The initial value of the partitioning character designated through the dropdown list 412 is hyphen.

The initial value of the toggle switch 413 is the instruction not to extract data from the image code, to set the file name.

The type of the one-dimensional code that can be designated through the dropdown list 414 includes the specific type of the one-dimensional code, and the “automatic detection” indicating that the capture system 20 automatically detects the type. In the case of the “automatic detection”, the specific type of the one-dimensional barcode that the capture system 20 attempts to detect, when the automatic detection has failed, may be designated.

The type of the two-dimensional code that can be designated through the dropdown list 415 includes the specific type of the one-dimensional code, and the “automatic detection” indicating that the capture system 20 automatically detects the type. In the case of the “automatic detection”, the specific type of the two-dimensional barcode that the capture system 20 attempts to detect, when the automatic detection has failed, may be designated.

The range that can be designated through the dropdown list 416 may be, for example, all of the data extracted from the image code included in the document, or a specific range in the data extracted from the image code included in the document, such as from the X-th to Y-th characters from the head.

As shown in FIG. 9, upon deciding that the OK button 418 has been pressed, after the operation of S123 is finished, the web browser 35a notifies the setting detail in the file name setting page 410, specified at the time that the OK button 418 has been pressed, to the capture system 20 (S124).

Upon receipt of the notice of S124, the capturer 25a of the capture system 20 validates the setting detail notified at S124, in the workflow management information 24d (S125).

Hereunder, an operation of the system 10, performed when the user logs in to the capture system 20 from the image reading apparatus 40, will be described.

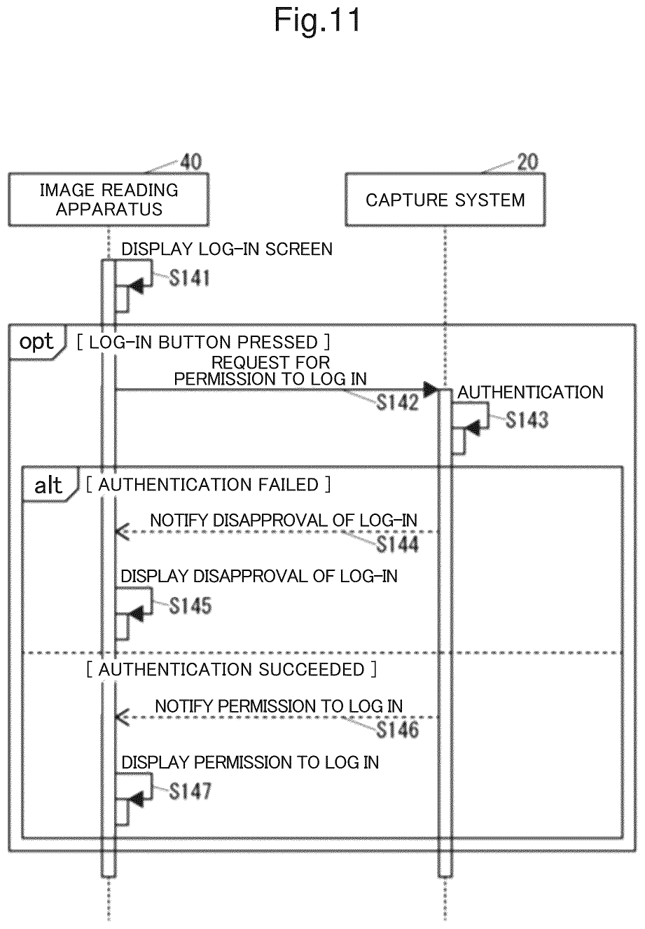

FIG. 11 is a sequence chart showing the operation of the system 10, performed when the user logs in to the capture system 20 from the image reading apparatus 40.

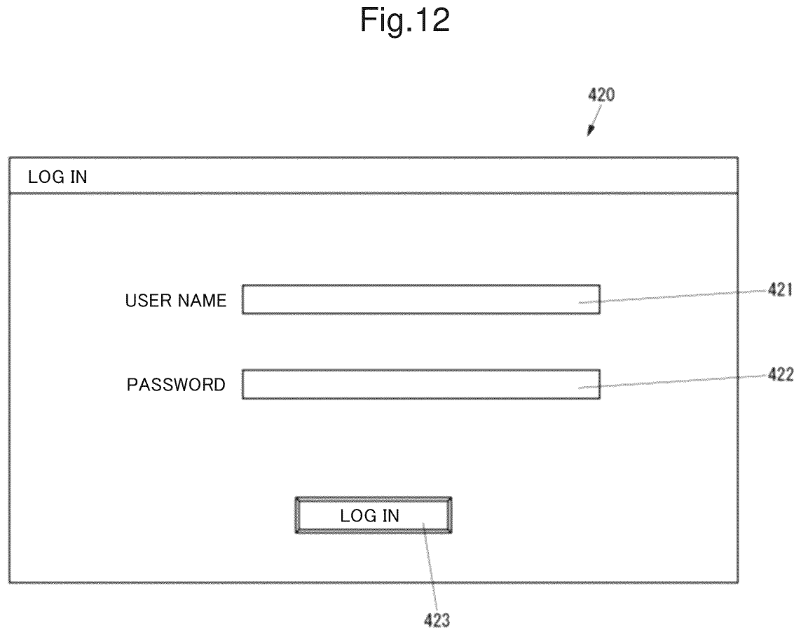

The user of the image reading apparatus 40 can instruct, via the operation device 41, the image reading apparatus 40 to display a screen for logging in to the capture system 20 (hereinafter, “log-in screen”). When the instruction to display the log-in screen is inputted, the workflow executer 48a of the image reading apparatus 40 displays the log-in screen 420 (see FIG. 12) on the display device 42 (S141).

FIG. 12 illustrates an example of the log-in screen 420.

The log-in screen 420 shown in FIG. 12 includes a textbox 421 which is a widget for inputting the user name, a textbox 422 which is a widget for inputting the password, and a log-in button 423 for logging in to the capture system 20.

Referring to FIG. 11, when the log-in button 423 is pressed, the workflow executer 48a of the image reading apparatus 40 requests the capture system 20 to permit the log-in, on the basis of the combination of the user name inputted to the textbox 421 at the time that the log-in button 423 has been pressed, and the password inputted to the textbox 422 at the time that the log-in button 423 has been pressed (S142).

Upon receipt of the request of S142, the capturer 25a of the capture system 20 performs authentication of the user who is the subject of the request of S124 (S143). To be more specific, the capturer 25a decides that the authentication has succeeded, when the combination of the user name and the password, included in the request of S142, is included in the user management information 24b. On the other hand, in the case where the combination of the user name and the password included in the request of S142 is not included in the user management information 24b, the capturer 25a decides that the authentication of the user has failed.

Upon deciding that the authentication performed at S143 has failed, the capturer 25a of the capture system 20 notifies the image reading apparatus 40 that log-in has been rejected (S144).

Upon receipt of the notice of S144, the workflow executer 48a of the image reading apparatus 40 displays a message to the effect that log-in has been rejected, on the display device 42 (S145).

In contrast, upon deciding that the authentication performed at S143 has succeeded, the capturer 25a of the capture system 20 notifies the image reading apparatus 40 that log-in has been permitted (S146).

Upon receipt of the notice of S146, the workflow executer 48a of the image reading apparatus 40 displays a message to the effect that log-in has been permitted, on the display device 42 (S147).

Hereunder, an operation of the system 10, performed when the capture system 20 executes the workflow, will be described.

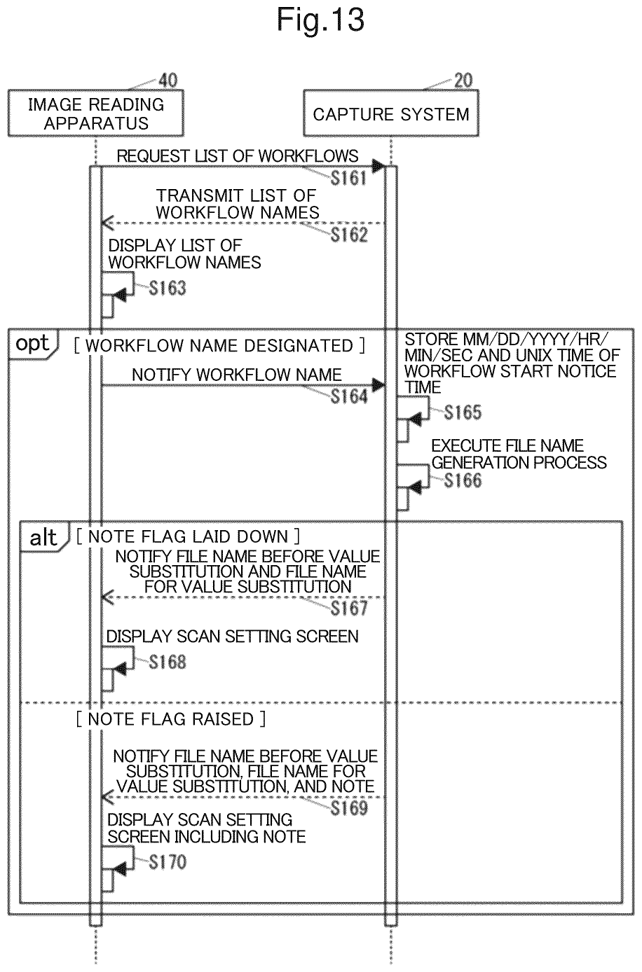

FIG. 13 is a sequence chart showing the operation of the system 10, performed when the capture system 20 executes the workflow.

The user in the logged-in state to the capture system 20 from the image reading apparatus 40 can instruct, via the operation device 41, the image reading apparatus 40 to display a list of the workflows. When the instruction to display the list of the workflows is inputted, the workflow executer 48a of the image reading apparatus 40 requests the capture system 20 to provide the list of the workflows, as shown in FIG. 13 (S161).

Upon receipt of the request of S161, the capturer 25a of the capture system 20 transmits the list of the workflow names included in the workflow management information 24d, to the image reading apparatus 40 (S162).

Upon receipt of the list transmitted at S162, the workflow executer 48a of the image reading apparatus 40 displays the list of the workflow names received, on the display device 42 (S163).

Therefore, in view of the list displayed on the display device 42, the user can designate the workflow name of the workflow to be executed by the capture system 20, via the operation device 41.

When the workflow name is designated after S163, the workflow executer 48a of the image reading apparatus 40 notifies the designated workflow name, to the capture system 20 (S164).

Upon receipt of the notice of S164, the capturer 25a of the capture system 20 stores therein the current MM/DD/YYYY, hr/min/sec, and UNIX time, as the MM/DD/YYYY, hr/min/sec, and UNIX time of the workflow start notice time (S165).

After S165, the capturer 25a executes a file name generation process, including generating the file name of the document, to be generated when the workflow identified by the workflow name notified at S164 is executed (S166).

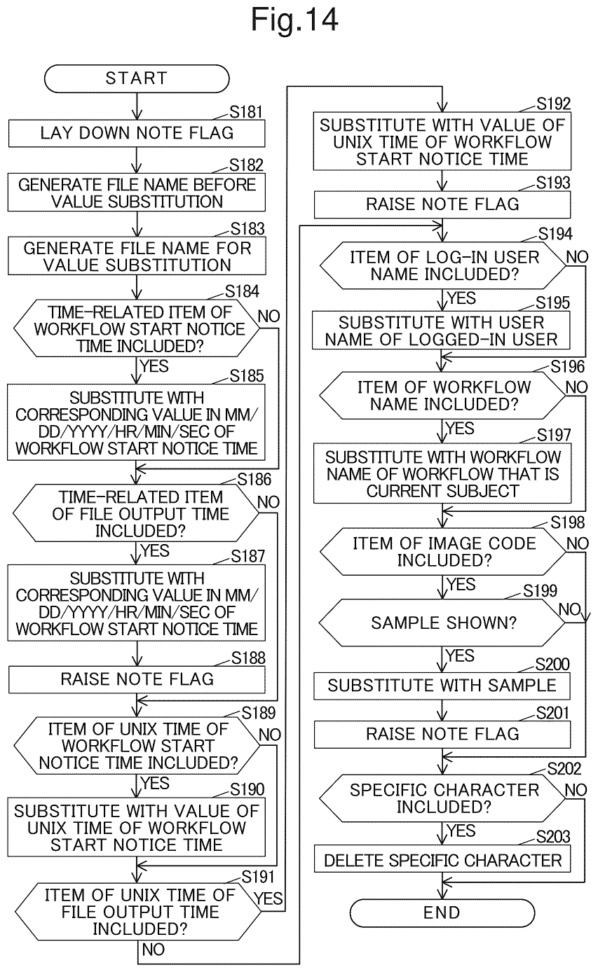

FIG. 14 is a flowchart showing the file name generation process included in FIG. 13.

As shown in FIG. 14, the capturer 25a lays down a note flag, indicating whether to display a note (S181).

After S181, the capturer 25a generates the file name, expressing the item of the metadata with the character string indicating the item of the metadata (hereinafter, “file name before value substitution”), on the basis of the file name structure metadata information and the partitioning character information, associated with the workflow name notified at S164 in the workflow management information 24d (S182). For example, the capturer 25a expresses the item “image code” of the metadata with the character string “{#input.barcode#}” indicating the item “image code” metadata.

After S182, the capturer 25a generates the file name for substituting the character string indicating the item, with a specific value (hereinafter, “file name for value substitution”), by copying the file name before value substitution generated at S182 (S183).

After S183, the capturer 25a decides whether the file name before value substitution generated at S182 includes the time-related item of the workflow start notice time (S184).

Upon deciding at S184 that the file name before value substitution generated at S182 includes the time-related item of the workflow start notice time, the capturer 25a substitutes the character string indicating the time-related item of the workflow start notice time, in the file name for value substitution of the current time, with the corresponding value in the MM/DD/YYYY/hr/min/sec stored at S165 (S185).

Upon deciding at S184 that the file name before value substitution generated at S182 does not include the time-related item of the workflow start notice time, or upon finishing the operation of S185, the capturer 25a decides whether the file name before value substitution generated at S182 includes the time-related item of the file output time (S186).

Upon deciding at S186 that the file name before value substitution generated at S182 includes the time-related item of the file output time, the capturer 25a substitutes the character string indicating the time-related item of the file output time, in the file name for value substitution of the current time, with the corresponding value in the MM/DD/YYYY/hr/min/sec stored at S165 (S187).

After S187, the capturer 25a raises the note flag (S188).

Upon deciding at S186 that the file name before value substitution generated at S182 does not include the time-related item of the file output time, or upon finishing the operation of S188, the capturer 25a decides whether the file name before value substitution generated at S182 includes the UNIX time of the workflow start notice time (S189).

Upon deciding at S189 that the file name before value substitution generated at S182 includes the UNIX time of the workflow start notice time, the capturer 25a substitutes the character string indicating the UNIX time of the workflow start notice time, in the file name for value substitution of the current time, with the value of the UNIX time stored at S165 (S190).

Upon deciding at S189 that the file name before value substitution generated at S182 does not include the UNIX time of the workflow start notice time, or upon finishing the operation of S190, the capturer 25a decides whether the file name before value substitution generated at S182 includes the item of the UNIX time of the file output time (S191).

Upon deciding at S191 that the file name before value substitution generated at S182 includes the item of the UNIX time of the file output time, the capturer 25a substitutes the character string indicating the UNIX time of the file output time, in the file name for value substitution of the current time, with the value of the UNIX time stored at S165 (S192).

After S192, the capturer 25a raises the note flag (S193).

Upon deciding at S191 that the file name before value substitution generated at S182 does not include the item of the UNIX time of the file output time, or upon finishing the operation of S193, the capturer 25a decides whether the file name before value substitution generated at S182 includes the item of the log-in user name (S194).

Upon deciding at S194 that the file name before value substitution generated at S182 includes the item of the log-in user name, the capturer 25a substitutes the character string indicating the log-in user name, in the file name for value substitution of the current time, with the user name of the user in the logged-in state to the capture system 20 (S195).

Upon deciding at S194 that the file name before value substitution generated at S182 does not include the item of the log-in user name, or upon finishing the operation of S195, the capturer 25a decides whether the file name before value substitution generated at S182 includes the item of the workflow name (S196).

Upon deciding at S196 that the file name before value substitution generated at S182 includes the item of the workflow name, the capturer 25a substitutes the character string indicating the workflow name, in the file name for value substitution of the current time, with the workflow name of the workflow that is the current subject of execution (S197).

Upon deciding at S196 that the file name before value substitution generated at S182 does not include the item of the workflow name, or upon finishing the operation of S197, the capturer 25a decides whether the file name before value substitution generated at S182 includes the item of “image code” (S198).

Upon deciding at S198 that the file name before value substitution generated at S182 includes the item of “image code”, the capturer 25a decides whether the sample is indicated in the image code sample data, associated with the workflow name notified at S164, in the workflow management information 24d (S199).

Upon deciding at S199 that the sample is indicated in the image code sample data, associated with the workflow name notified at S164 in the workflow management information 24d, the capturer 25a substitutes the character string indicating the item of the image code, in the file name for value substitution of the current time, with the sample indicated in the image code sample data, associated with the workflow name notified at S164, in the workflow management information 24d (S200).

After S200, the capturer 25a raises the note flag (S201).

Upon deciding at S198 that the file name before value substitution generated at S182 does not include the item of “image code”, or deciding at S199 that the sample is not indicated in the image code sample data, associated with the workflow name notified at S164 in the workflow management information 24d, or upon finishing the operation of S201, the capturer 25a decides whether the file name for value substitution of the current time includes a specific character (S202). Here, the specific character may be a character, the use of which in the file name is prohibited by a specific operating system (OS), such as “\”, “/”, “:”, “*”, “?”, “<”, “>”, or “|”.

Upon deciding at S202 that the file name for value substitution of the current time includes the specific character, the capturer 25a deletes the specific character from the file name for value substitution of the current time (S203).

Upon deciding at S202 that the file name for value substitution of the current time does not include the specific character, or upon finishing the operation of S203, the capturer 25a finishes the file name generation process specified in FIG. 14.

Referring to FIG. 13, in the case where the note flag of the current time is laid down, when the file name generation process of S166 is finished, the capturer 25a of the capture system 20 notifies the file name before value substitution generated at S182, and the file name for value substitution of the current time, to the image reading apparatus 40 (S167).

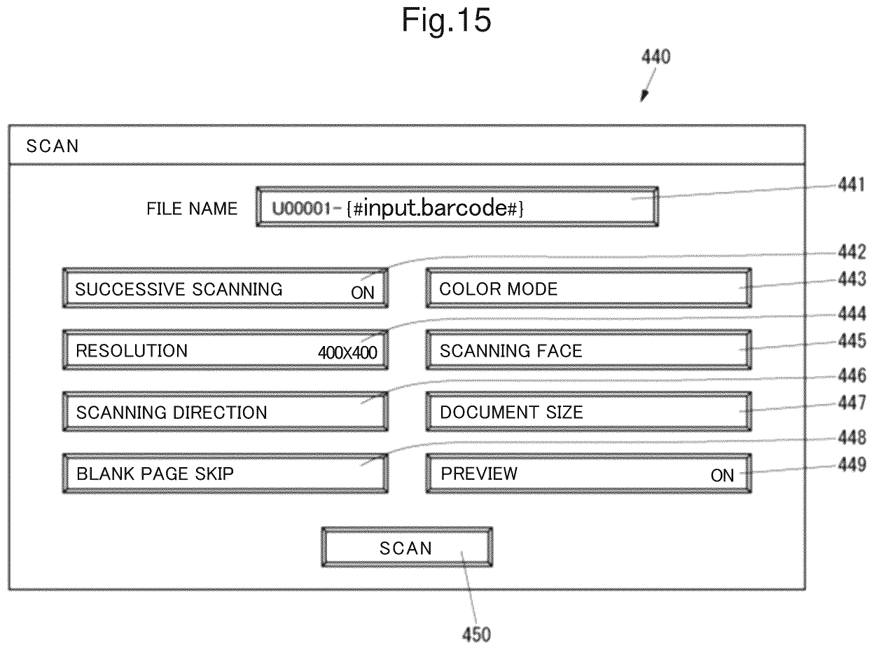

Upon receipt of the file name before value substitution and the file name for value substitution, notified at S167, the workflow executer 48a of the image reading apparatus 40 displays a screen 440 (see FIG. 15) for generating a scanned image to be transmitted to the capture system 20 (hereinafter, “scan setting screen”), on the display device 42 (S168).

FIG. 15 illustrates an example of the scan setting screen 440.

As shown in FIG. 15, the scan setting screen 440 includes a file name button 441 which is a widget for editing the file name, a successive scanning button 442 which is a widget for enabling or disabling successive scanning, including sequentially reading a plurality of documents, a color mode button 443 which is a widget for designating a color mode for reading the document, a resolution button 444 which is a widget for designating the resolution for reading the document, a scanning face button 445 which is a widget for designating which of simplex reading and duplex reading is to be performed, a scanning direction button 446 which is a widget for designating the direction in which the document is to be set with respect to the scanner 44, a document size button 447 which is a widget for designating the size of the document, a blank page skip button 448 which is a widget for allowing the scanner 44 to skip a blank page, when the document includes a blank page, a preview button 449 which is a widget for instructing whether to confirm the image read from the document, before transmitting the image to the capture system 20, and a scan button 450 for executing the scanning operation by the scanner 44.

The workflow executer 48a displays the file name for value substitution received from the capture system 20, in the file name button 441.

The successive scanning button 442 can display, by being pressed, “On” indicating that the successive scanning is enabled, and “Off” indicating that the successive scanning is disabled. In FIG. 15, the successive scanning button 442 is set to “On”.

By pressing the color mode button 443, for example, one of the following modes can be designated. “Automatic color/gray scale” representing a color mode including automatically deciding whether the document is colored or monochrome, reading the document in full-color when the document is colored, and reading the document in gray scale when the document is monochrome; “automatic color/monochrome” representing a color mode including automatically deciding whether the document is colored or monochrome, reading the document in full-color when the document is colored, and reading the document as a monochrome binary image when the document is monochrome; “full-color” representing a color mode of reading the document in full-color; “gray scale” representing a color mode of reading the document in gray scale; and “monochrome” representing a color mode of reading the document as a monochrome binary image. In FIG. 15, the color mode button 443 is set to “automatic color/gray scale”.

By pressing the resolution button 444, for example, one of “600×600” indicating the resolution of 600 dpi×600 dpi, “400×400” indicating the resolution of 400 dpi×400 dpi, “300×300” indicating the resolution of 300 dpi×300 dpi, and “200×200” indicating the resolution of 200 dpi×200 dpi can be designated. In FIG. 15, the resolution button 444 is set to “400×400”.

By pressing the scanning face button 445, for example, one of “simplex” indicating that one face of the document is to be read, and “duplex” indicating that both faces of the document are to be read, can be designated. In FIG. 15, the scanning face button 445 is set to “simplex”.

By pressing the scanning direction button 446, for example, one of “upper edge on far side”, indicating that the document to be read by the scanner 44 is to be set with the upper edge of the document oriented to the far side, with respect to the scanner 44, and “upper edge on left side” indicating that the document to be read by the scanner 44 is to be set with the upper edge of the document oriented to the left side, with respect to the scanner 44, can be designated. In FIG. 15, the scanning direction button 446 is set to “upper edge on far side”.

By pressing the document size button 447, for example, one of “automatic” indicating that the document size is automatically detected, “A3” indicating that the document is of A3 size, “A4” indicating that the document is of A4 size, “A5” indicating that the document is of A5 size, “B4” indicating that the document is of B4 size, “B5” indicating that the document is of B5 size, and “B6” indicating that the document is of B6 size, can be designated. In FIG. 15, the document size button 447 is set to “automatic”.

By pressing the blank page skip button 448, for example, one of “off” indicating that a blank page is not to be skipped, “low” indicating that the blank page is to be skipped, on the basis of a laxest criterion for deciding that the page is blank, “medium” indicating that the blank page is to be skipped, on the basis of a second laxest criterion for deciding that the page is blank, and “high” indicating that the blank page is to be skipped, on the basis of a strictest criterion for deciding that the page is blank, can be designated. In FIG. 15, the blank page skip button 448 is set to “medium”.

By pressing the preview button 449, one of “On” indicating that the image read from the document is to be confirmed before being transmitted to the capture system 20, and “Off” indicating that the image read from the document is not to be confirmed before being transmitted to the capture system 20, can be designated. In FIG. 15, the preview button 449 is set to “On”.

Referring to FIG. 13, in the case where the note flag of the current time is raised, when the file name generation process of S166 is finished, the capturer 25a of the capture system 20, notifies the file name before value substitution generated at S182, the file name for value substitution of the current time, and the note, to the image reading apparatus 40 (S169).

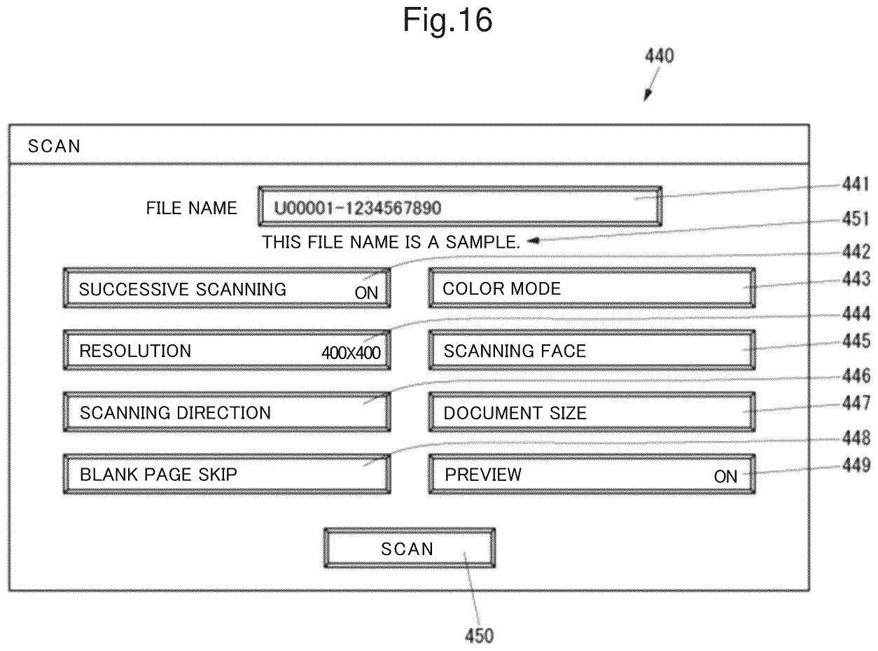

Upon receipt of the file name before value substitution, the file name for value substitution, and the note, notified at S169, the workflow executer 48a of the image reading apparatus 40 displays a scan setting screen 440 (see FIG. 16) including the note, on the display device 42 (S170).

FIG. 16 illustrates an example of the scan setting screen 440, including the note.

The scan setting screen 440 shown in FIG. 16 includes, unlike the scan setting screen 440 shown in FIG. 15, a text 451 indicating a note to the effect that “the file name is a sample”. In other words, the workflow executer 48a displays the note received from the capture system 20, in the form of the text 451.

The workflow executer 48a displays the file name for value substitution received from the capture system 20, in the file name button 441.

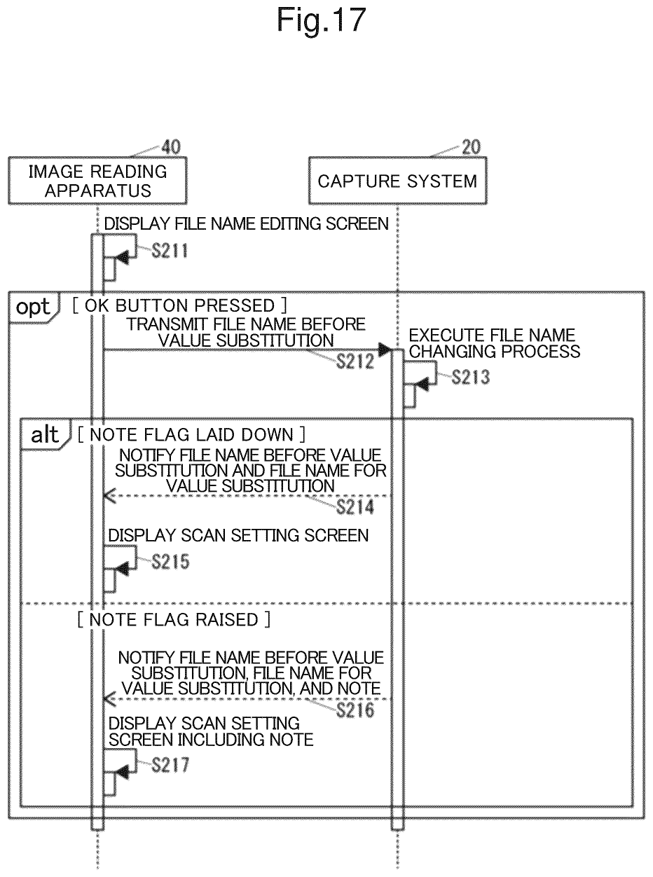

FIG. 17 is a sequence chart showing the operation of the system 10, performed when the file name button 441 is pressed.

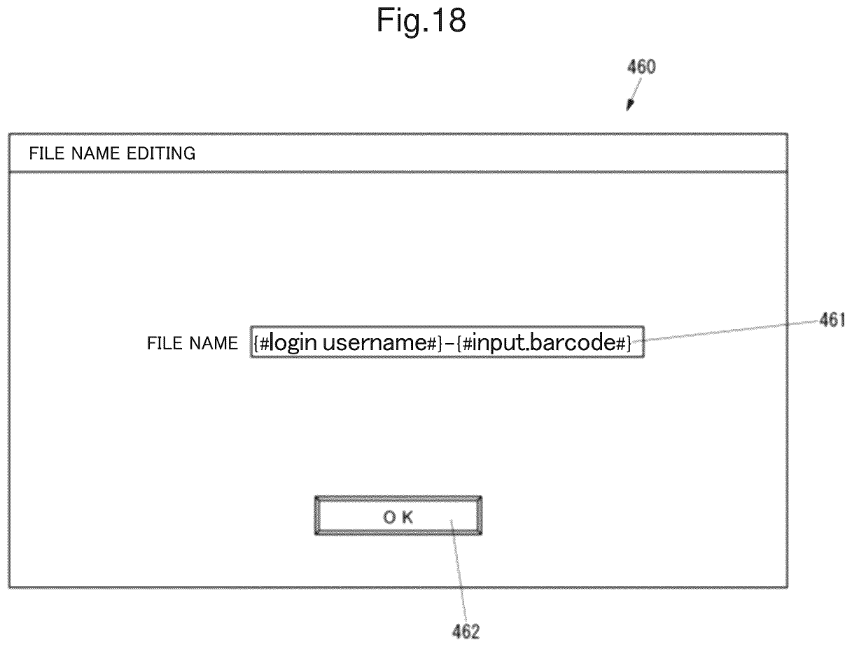

When the scan setting screen 440 is displayed on the display device 42, the user can press the file name button 441, via the operation device 41. When the file name button 441 is pressed, the workflow executer 48a of the image reading apparatus 40 displays a screen 460 (see FIG. 18) for editing the file name (hereinafter, “file name editing screen”) on the display device 42, as shown in FIG. 17 (S211).

FIG. 18 illustrates an example of the file name editing screen 460.

As shown in FIG. 18, the file name editing screen 460 includes a textbox 461 which is a widget for editing the file name, and an OK button 462 which is a widget for finishing the editing of the file name.

When displaying the file name editing screen 460 at S211, the workflow executer 48a displays the latest file name before value substitution received from the capture system 20, as the initial value in the textbox 461.

The user can change the file name displayed in the textbox 461, via the operation device 41.

Referring to FIG. 17, when the OK button 462 is pressed after the operation of S211 is finished, the workflow executer 48a of the image reading apparatus 40 transmits the file name before value substitution, displayed in the textbox 461 at the time that the OK button 462 has been pressed, to the capture system 20 (S212).

Upon receipt of the file name before value substitution transmitted at S212, the capturer 25a of the capture system 20 executes a file name changing process, including changing the file name of the document to be generated when the workflow, identified by the workflow name notified at S164, is executed (S213).

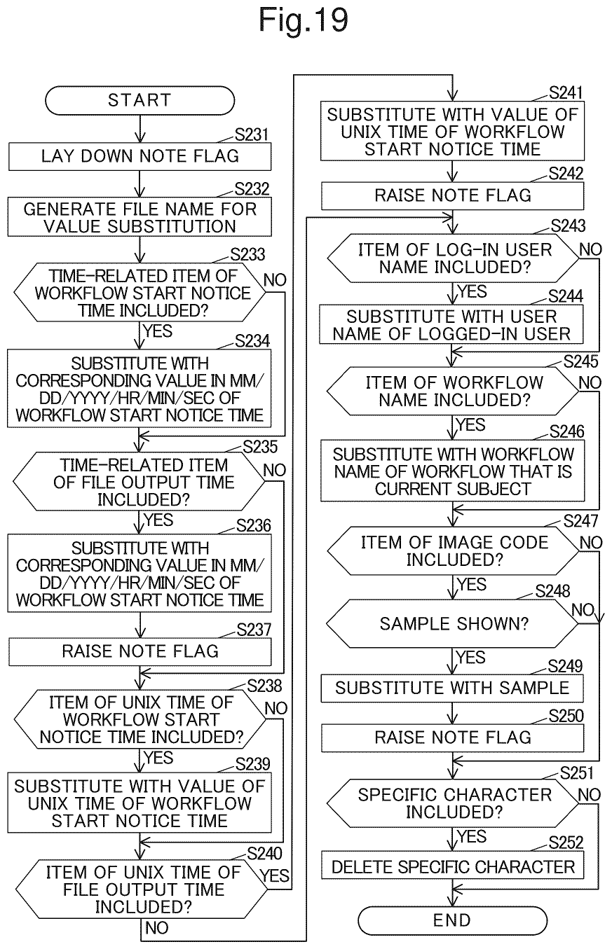

FIG. 19 is a flowchart showing the file name changing process included in FIG. 17.

Referring to FIG. 19, the capturer 25a lays down the note flag (S231).

After S231, the capturer 25a generates the file name for value substitution, by copying the file name before value substitution transmitted at S212 (S232).

After S232, the capturer 25a decides whether the file name before value substitution transmitted at S212 includes the time-related item of the workflow start notice time (S233).

Upon deciding at S233 that the file name before value substitution transmitted at S212 includes the time-related item of the workflow start notice time, the capturer 25a substitutes the character string indicating the time-related item of the workflow start notice time, in the file name for value substitution of the current time, with the corresponding value in the MM/DD/YYYY/hr/min/sec stored at S165 (S234).

Upon deciding at S233 that the file name before value substitution transmitted at S212 does not include the time-related item of the workflow start notice time, or upon finishing the operation of S234, the capturer 25a decides whether the file name before value substitution transmitted at S212 includes the time-related item of the file output time (S235).

Upon deciding at S235 that the file name before value substitution transmitted at S212 includes the time-related item of the file output time, the capturer 25a substitutes the character string indicating the time-related item of the file output time, in the file name for value substitution of the current time, with the corresponding value in the MM/DD/YYYY/hr/min/sec stored at S165 (S236).

Upon finishing the operation of S236, the capturer 25a raises the note flag (S237).

Upon deciding at S235 that the file name before value substitution transmitted at S212 does not include the time-related item of the file output time, or upon executing the operation of S237, the capturer 25a decides whether the file name before value substitution transmitted at S212 includes the item of UNIX time of the workflow start notice time (S238).

Upon deciding that the file name before value substitution transmitted at S212 includes the item of UNIX time of the workflow start notice time, the capturer 25a substitutes the character string indicating the item of UNIX time of the workflow start notice time, in the file name for value substitution of the current time, with the value of the UNIX time stored at S165 (S239).

Upon deciding that the file name before value substitution transmitted at S212 does not include the item of UNIX time of the workflow start notice time, or upon finishing the operation of S239, the capturer 25a decides whether the file name before value substitution transmitted at S212 includes the item of UNIX time of the file output time (S240).

Upon deciding at S240 that the file name before value substitution transmitted at S212 includes the item of UNIX time of the file output time, the capturer 25a substitutes the character string indicating the item of UNIX time of the file output time, in the file name for value substitution of the current time, with the value of the UNIX time stored at S165 (S241).

Upon finishing the operation of S241, the capturer 25a raises the note flag (S242).

Upon deciding at S240 that the file name before value substitution transmitted at S212 does not include the item of UNIX time of the file output time, or upon finishing the operation of S242, the capturer 25a decides whether the file name before value substitution transmitted at S212 includes the item of log-in user name (S243).

Upon deciding at S243 that the file name before value substitution transmitted at S212 includes the item of log-in user name, the capturer 25a substitutes the character string indicating the log-in user name, in the file name for value substitution of the current time, with the user name of the user in the logged-in state to the capture system 20 (S244).

Upon deciding at S243 that the file name before value substitution transmitted at S212 does not include the item of log-in user name, or upon finishing the operation of S244, the capturer 25a decides whether the file name before value substitution transmitted at S212 includes the item of workflow name (S245).

Upon deciding at S245 that the file name before value substitution transmitted at S212 includes the item of workflow name, the capturer 25a substitutes the character string indicating the workflow name, in the file name for value substitution of the current time, with the workflow name of the workflow that is the current subject of execution (S246).

Upon deciding at S245 that the file name before value substitution transmitted at S212 does not include the item of workflow name, or upon finishing the operation of S246, the capturer 25a decides whether the file name before value substitution transmitted at S212 includes the item of “image code” (S247).

Upon deciding at S247 that the file name before value substitution transmitted at S212 includes the item of “image code”, the capturer 25a decides whether the sample is indicated in the image code sample data, associated with the workflow name notified at S164 in the workflow management information 24d (S248).

Upon deciding at S248 that the sample is indicated in the image code sample data, associated with the workflow name notified at S164 in the workflow management information 24d, the capturer 25a substitutes the character string indicating the item of image code, in the file name for value substitution of the current time, with the sample indicated in the image code sample data, associated with the workflow name notified at S164 in the workflow management information 24d (S249).

Upon finishing the operation of S249, the capturer 25a raises the note flag (S250).

Upon deciding at S247 that the file name before value substitution transmitted at S212 does not include the item of “image code”, or deciding at S248 that the sample is not indicated in the image code sample data, associated with the workflow name notified at S164 in the workflow management information 24d, or upon finishing the operation of S250, the capturer 25a decides whether the file name for value substitution of the current time includes a specific character (S251). Here, the specific character may be a character, the use of which in the file name is prohibited by a specific OS, such as “\”, “/”, “:”, “*”, “?”, “<”, “>”, or “|”.

Upon deciding at S251 that the file name for value substitution of the current time includes a specific character, the capturer 25a deletes the specific character, from the file name for value substitution of the current time (S252).

Upon deciding at S251 that the file name for value substitution of the current time does not include a specific character, or upon finishing the operation of S252, the capturer 25a finishes the execution of the file name changing process specified in FIG. 19.

Referring to FIG. 17, in the case where the note flag of the current time is laid down., when the execution of the file name changing process of S213 is finished, the capturer 25a of the capture system 20 notifies the file name before value substitution transmitted at S212, and the file name for value substitution of the current time, to the image reading apparatus 40 (S214).

Upon receipt of the file name before value substitution transmitted at S212, and the file name for value substitution of the current time, notified at S214, the workflow executer 48a of the image reading apparatus 40 displays the scan setting screen 440 (see FIG. 15), on the display device 42 (S215). The workflow executer 48a displays the file name for value substitution received from the capture system 20, in the file name button 441.

In the case where the note flag of the current time is raised, when the file name changing process of S213 is finished, the capturer 25a of the capture system 20 notifies the file name before value substitution transmitted at S212, the file name for value substitution of the current time, and the note, to the image reading apparatus 40 (S216).

Upon receipt of the file name before value substitution, the file name for value substitution of the current time, and the note notified at S216, the workflow executer 48a of the image reading apparatus 40 displays the scan setting screen 440 including the note (see FIG. 16), on the display device 42 (S217). The workflow executer 48a displays the file name for value substitution received from the capture system 20 in the file name button 441, and the note received from the capture system 20 in the form of the text 451.

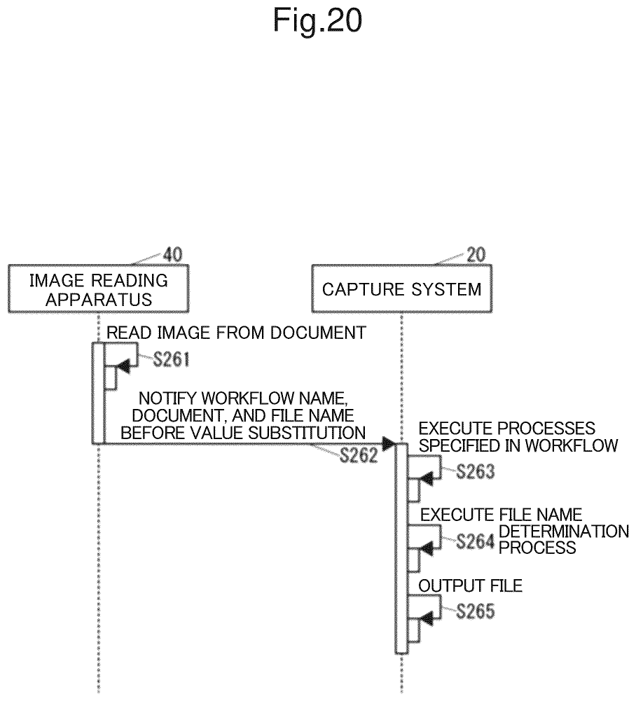

FIG. 20 is a sequence chart showing the operation of the system 10, performed when the scan button 450 is pressed.

When the scan setting screen 440 is displayed on the display device 42, the user can press the scan button 450 via the operation device 41. When the scan button 450 is pressed, the workflow executer 48a of the image reading apparatus 40 reads the image from the document using the scanner 44, as shown in FIG. 20, according to the setting detail specified in the scan setting screen 440 (S261).

After S261, the workflow executer 48a transmits the workflow name notified to the capture system 20 at S164, the document represented by the image generated at S261, and the file name before value substitution of the current time, to the capture system 20 (S262).

Here, when the preview button 449 is set to “On” in the scan setting screen 440, the workflow executer 48a displays the image generated at S261 on the display device 42, before executing the operation of S262.

Upon receipt of the workflow name, the document, and the file name before value substitution transmitted at S262, the capturer 25a of the capture system 20 executes the processings specified in the workflow, identified by the workflow name transmitted at S262, with respect to the document transmitted at S262 (S263).

After S263, the capturer 25a executes a file name determination process, for determining the file name of the document (S264).

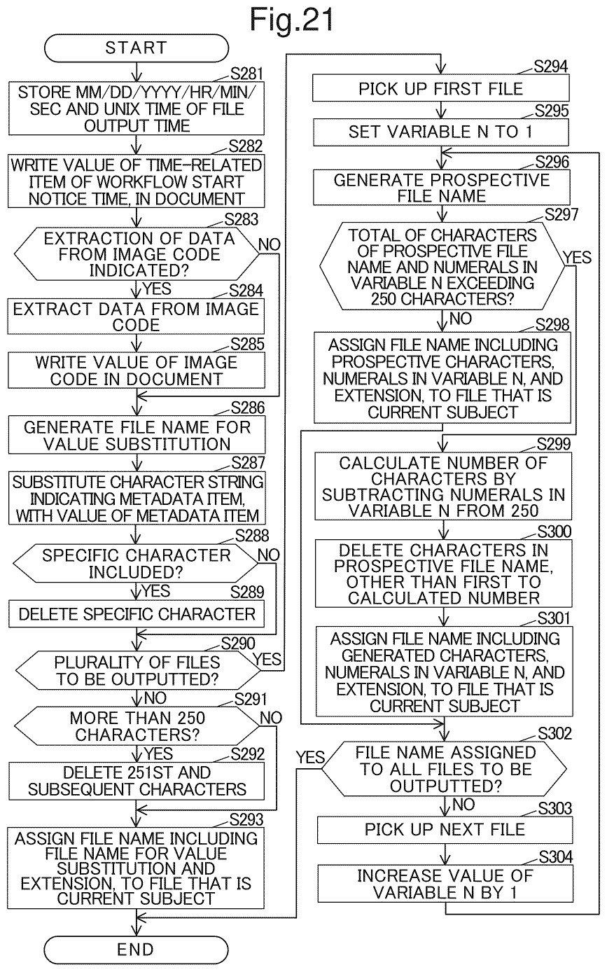

FIG. 21 is a flowchart showing the file name determination process included in FIG. 20.

As shown in FIG. 21, the capturer 25a stores therein the current MM/DD/YYYY/hr/min/sec and UNIX time, as the MM/DD/YYYY/hr/min/sec and UNIX time of the file output time (S281).

After S281, the capturer 25a writes the MM/DD/YYYY/hr/min/sec stored at S165, the MM/DD/YYYY/hr/min/sec stored at S281, the UNIX time stored at S165, the UNIX time stored at S281, the user name of the user in the logged-in state to the capture system 20, and the workflow name of the workflow currently to be executed, in the document transmitted at S262, as the value of the time-related item of the workflow start notice time, the value of the time-related item of the file output time, the value of the “UNIX time” of the workflow start notice time, the value of the “UNIX time” of the file output time, the value of the “log-in user name”, and the value of the “workflow name”, respectively (S282).

After S282, the capturer 25a decides whether extraction of the data from the image code to set the file name is indicated in the code recognition information, associated with the workflow name transmitted at S262 in the workflow management information 24d (S283).

Upon deciding at S283 that the extraction of the data from the image code to set the file name is indicated in the code recognition information, associated with the workflow name transmitted at S262 in the workflow management information 24d, the capturer 25a extracts the data from the image code in the document transmitted at S262, according to the one-dimensional code type information, the two-dimensional code type information, and the data range information, associated with the workflow name transmitted at S262 in the workflow management information 24d (S284).

After S284, the capturer 25a writes the data extracted at S284 in the document transmitted at S262, as the value of the metadata “image code” (S285).

Upon deciding at S283 that the extraction of the data from the image code to set the file name is not indicated in the code recognition information, associated with the workflow name transmitted at S262 in the workflow management information 24d, or upon finishing the operation of S285, the capturer 25a generates the file name for value substitution, by copying the file name before value substitution transmitted at S262 (S286).

After S286, the capturer 25a substitutes the character string indicating the item of the metadata, in the file name for value substitution of the current time, with the value of the corresponding item of the metadata in the document that is the current subject (S287).

After S287, the capturer 25a decides whether the file name for value substitution of the current time includes a specific character (S288). Here, the specific character may be a character, the use of which in the file name is prohibited by a specific OS, such as “\”, “/”, “:”, “*”, “?”, “<”, “>”, or “|”.

Upon deciding at S288 that the file name for value substitution of the current time includes a specific character, the capturer 25a deletes the specific character, from the file name for value substitution of the current time (S289).

Upon deciding at S288 that the file name for value substitution of the current time does not include a specific character, or upon finishing the operation of S289, the capturer 25a decides whether a plurality of files are to be outputted (S290). For example, when the format of the output file, specified in the workflow identified by the workflow name transmitted at S262, is JPEG file, and the document transmitted at S262 includes a plurality of pages of images, the capturer 25a can decide that a plurality of files are to be outputted.

Upon deciding at S290 that a plurality of files are not to be outputted, the capturer 25a decides whether the number of characters in the file name for value substitution of the current time is larger than 250 characters (S291).

Upon deciding at S291 that the number of characters in the file name for value substitution of the current time is larger than 250 characters, the capturer 25a deletes the 251st and subsequent characters from the head, in the file name for value substitution of the current time (S292).

Upon deciding at S291 that the number of characters in the file name for value substitution of the current time is not larger than 250 characters, or upon finishing the operation of S292, the capturer 25a assigns, to the file that is the current subject, the file name generated by adding an extension according to the format of the output file, specified in the workflow identified by the workflow name transmitted at S262, to the file name for value substitution of the current time (S293), and finishes the file name determination process specified in FIG. 21.

Upon deciding at S290 that a plurality of files are to be outputted (YES at S290), the capturer 25a picks up a first file of the files to be outputted, as the subject (S294).

After S294, the capturer 25a sets the value of a variable N to 1 (S295).

After S295, the capturer 25a generates a prospective file name for the file that is the current subject, by copying the file name for value substitution of the current time (S296).

The capturer 25a decides whether the total of the number of characters of the prospective file name generated at S296, and the number of characters in the current variable N is larger than 250 characters (S297).

Upon deciding at S297 that the total of the number of characters of the prospective file name generated at S296, and the number of characters in the current variable N is not larger than 250 characters, the capturer 25a assigns, to the file that is the current subject, the file name generated by adding an extension according to the format of the output file specified in the workflow, identified by the workflow name transmitted at S262, to the character string formed by adding the numeral included in the current variable N, after the characters of the prospective file name generated at S296 (S298).

Upon deciding at S297 that the total of the number of characters of the prospective file name generated at S296, and the number of characters in the current variable N is larger than 250 characters, the capturer 25a calculates the number of characters by subtracting the number of characters of the numeral included in the current variable N, from 250 characters (S299).

After S299, the capturer 25a deletes the characters in the prospective file name generated at S296, other than the characters from the head to the character corresponding to the number of characters calculated at S299 (S300).

The capturer 25a assigns, to the file that is the current subject, the file name generated by adding the extension according to the format of the output file specified in the workflow, identified by the workflow name transmitted at S262, to the character string formed by adding the numeral included in the current variable N, after the characters generated at S300 (S301).

After S298 or S301, the capturer 25a decides whether the file name has been assigned to all the files to be outputted (S302).

Upon deciding at S302 that the file name has not yet been assigned to one or more files to be outputted, the capturer 25a picks up the file next to the current file to be outputted, as the subject (S303).

After S303, the capturer 25a increases the value of the variable N by 1 (S304), and executes the operation of S296.

Upon deciding at S302 that the file name has been assigned to all the files to be outputted, the capturer 25a finishes the file name determination process specified in FIG. 21.

Referring to FIG. 20, when the file name determination process of S264 is finished, the capturer 25a outputs the output file to the destination, specified in the workflow identified by the workflow name transmitted at S262 (S265).

As described thus far, when only the workflow name is transmitted at S164, out of the workflow name and the document, the capture system 20 generates, according to the rule, the sample of the file name, representing the execution result of a specific process based on the workflow with respect to the document (S166), transmit the sample of the file name to the transmission source of the workflow name of the workflow (S167), and assigns the file name to the file according to the rule, when the document, represented by the image read from the document by the image reading apparatus 40, is transmitted at S262 from the transmission source of the workflow name of the workflow (S264). The mentioned arrangement enables the user to recognize, before the image reading apparatus 40 reads the image from the document, the file name of the file, representing the execution result of the specific process according to the workflow, with respect to the document represented by the image read from the document by the image reading apparatus 40 at S261.

After transmitting only the workflow name at S164, out of the workflow name and the document, to the capture system 20, the image reading apparatus 40 receives and displays the sample of the file name from the capture system 20 (S168 or S170), reads the image from the document with the scanner 44 after displaying the sample of the file name (S261), and transmits the image read from the document by the scanner 44 to the capture system 20, as the document (S262). The mentioned arrangement enables the user to recognize, before the image reading apparatus 40 reads the image from the document, the file name of the file representing the execution result of the specific process according to the workflow, with respect to the document represented by the image read from the document by the scanner 44 at S261.

The rule specifies that the file name includes the value for the item, for which the value is determined after transmission of the document, in other words the value of the item, for which the value is determined after the document is transmitted from the transmission source of the workflow name, and the capture system 20 generates the sample of the file name, using the substitutional value as the value of the item which is determined after transmission of the document (S187, S192, S200, S236, S241, or S249). The mentioned arrangement facilitates the user to perceive the actual file name of the file, with the sample of the file name.

The item for which the value is determined after transmission of the document includes the time-related item after transmission of the document, corresponding to the item for the value based on a time of a specific timing after the document has been transmitted from the transmission source of the workflow name, and the capture system 20 determines the substitutional value for the time-related item after transmission of the document, on the basis of the time of the specific timing before the generation of the sample of the file name (S187, S192, S236, or S241). The mentioned arrangement facilitates the user to perceive the actual file name of the file, with the sample of the file name.

The document represented by the image read from the document by the image reading apparatus 40 includes the image code, and the item for which the value is determined after transmission of the document includes the image code item which is the item for the value extracted from the image code included in the document. The capture system 20 extracts the value from the image code included in the document transmitted from the transmission source of the workflow name, generates the file name using the extracted value, stores therein the substitutional value of the image code item (S125), and generates the sample of the file name using the substitutional value stored (S200 or S249). The mentioned arrangement facilitates the user to perceive the actual file name of the file, with the sample of the file name.

The rule specifies that the document represented by the image read from the document by the image reading apparatus 40 includes the image code, and that the file name includes the value extracted from the image code included in the document, and the capture system 20 extracts the value from the image code included in the document transmitted from the transmission source of the workflow name of the workflow (S284), and generates the file name of the file using the extracted value (S287). The mentioned arrangement facilitates the generation of the file name appropriate for the document.

In the case of existing systems, unlike the case of the system according to the foregoing embodiment, the user is unable to recognize, before the image reading apparatus reads the image from the document, the file name of the file, representing the execution result of a specific process according to the workflow with respect to the document, represented by the image read from the document by the image reading apparatus.

According to the foregoing embodiment, in contrast, the user can recognize, before the image reading apparatus 40 reads the image from the document, the file name of the file, representing the execution result of a specific process according to the workflow with respect to the document, represented by the image read from the document by the image reading apparatus 40.

While the present disclosure has been described in detail with reference to the embodiments thereof, it would be apparent to those skilled in the art that various changes and modifications may be made therein within the scope defined by the appended claims. What is claimed is;

1. A capture system comprising a first control device including a processor, and configured to act as a capturer, when the processor executes a capture program,
the capturer being configured to:
execute a workflow including executing a specific process with respect to an inputted document, and outputting a file representing an execution result, to a specific destination;
store therein a rule for generating a file name, representing a name of the file, with respect to each of the workflows;
generate, upon receipt of only identification information, out of the identification information of the workflow and the document, a sample of the file name according to the rule, and transmit the sample to a transmission source of the identification information; and
assign the file name according to the rule to the file, upon receipt of the document from the transmission source.

2. The capture system according to claim 1,
wherein the rule specifies that the file name includes a value for an item for which the value is determined after transmission of the document, corresponding to the item for which the value is determined after the document is transmitted from the transmission source, and
the capturer generates the sample using a substitutional value, corresponding to the value for the item for which the value is determined after transmission of the document.

3. The capture system according to claim 2,
wherein the item for which the value is determined after transmission of the document includes a time-related item after transmission of the document, corresponding to the item for the value based on a time of a specific timing after the document was transmitted from the transmission source, and
the capturer determines the substitutional value for the time-related item after transmission of the document, on a basis of the time of the specific timing before the sample is generated.

4. The capture system according to claim 2,
wherein the document includes an image code,
the item for which the value is determined after transmission of the document includes an image code item for the value extracted from the image code included in the document,
the capturer extracts the value from the image code included in the document transmitted from the transmission source, and generates the file name using the extracted value, and
the capturer stores therein the substitutional value for the image code item, and generates the sample using the substitutional value stored.

5. The capture system according to claim 1,
wherein the document includes an image code,
the rule specifies that the file name includes a value extracted from the image code included in the document, and
the capturer extracts the value from the image code included in the document transmitted from the transmission source, and generates the file name using the extracted value.

6. A computer-readable, non-transitory recording medium having a capture program recorded thereon, the capture program being configured to cause the computer to act as a capturer that executes a workflow including executing a specific process with respect to an inputted document, and outputting a file representing an execution result, to a specific destination,
wherein the capturer stores therein a rule for generating a file name, representing a name of the file, with respect to each of the workflows,
upon receipt of only identification information, out of the identification information of the workflow and the document, the capturer generates a sample of the file name according to the rule, and transmits the sample to a transmission source of the identification information, and
upon receipt of the document from the transmission source, the capturer assigns the file name according to the rule, to the file.

7. An image reading apparatus comprising:
a reading device that reads an image from a source document;
a display device; and
a second control device including a processor, and configured to act as a workflow executer, when the processor executes a workflow execution program,
the workflow executer being configured to:
cause a capture system that executes a workflow including executing a specific process with respect to a document, and outputting a file representing an execution result to a specific destination, to execute the workflow;
receive a sample of a file name, representing a name of the file, from the capture system, after transmitting only identification information, out of the identification information of the workflow and the document, and display the sample on the display device; and
read the image from the source document using the reading device, after displaying the sample, and transmit the image to the capture system, as the document.

8. The image reading apparatus according to claim 7,
wherein the workflow executer transmits only the identification information to the capture system, at a time before the reading device reads the image from the document.

9. A system comprising:
a capture system including a first control device, including a processor and configured to act as a capturer, when the processor executes a capture program, the capturer being configured to execute a workflow including executing a specific process with respect to an inputted document, and outputting a file representing an execution result, to a specific destination; and
the image reading apparatus according to claim 7,
wherein, upon receipt of the document from the image reading apparatus, the capturer assigns the file name according to a predetermined rule for generating the file name representing the name of the file, to the file.
